(19) United States
(12) Patent Application Publication
(10) Pub. No.: US 2015/0282276 A1
(43) Pub. Date: Oct. 1, 2015

(54) Wi-Fi Control

(71) Applicant: Rodney L. Bates, Mountain House, CA (US)

(72) Inventor: Rodney L. Bates, Mountain House, CA (US)

(21) Appl. No.: 14/226,651

(22) Filed: Mar. 26, 2014

(51) Int. Cl. H05B 37/02

(52) U.S. Cl. CPC H05B 37/0218

(57) ABSTRACT

Millions of people today currently use wireless internet access. One can take their laptop computer from home to the coffee shop and still get Internet access. No wired connection is required between the PC and the Internet connection; radio waves are used for communication.

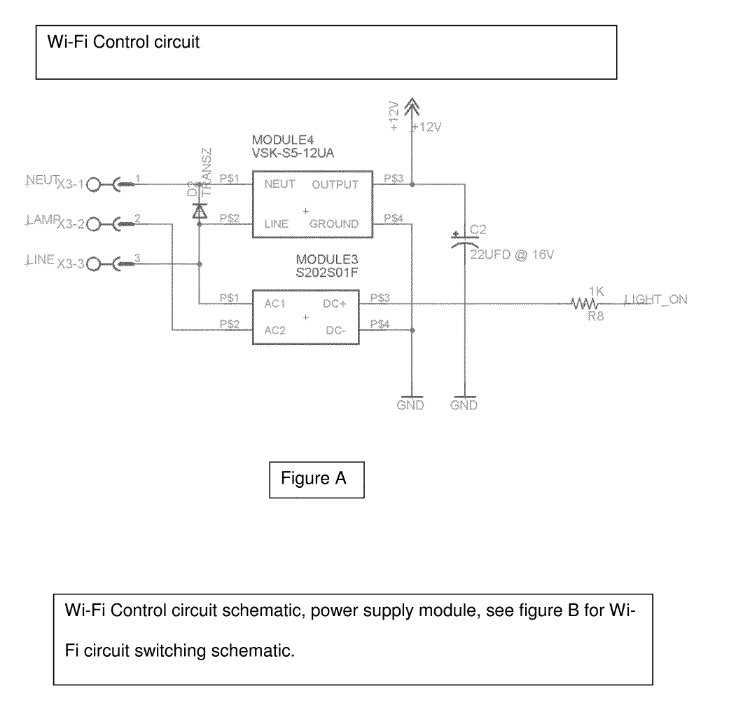

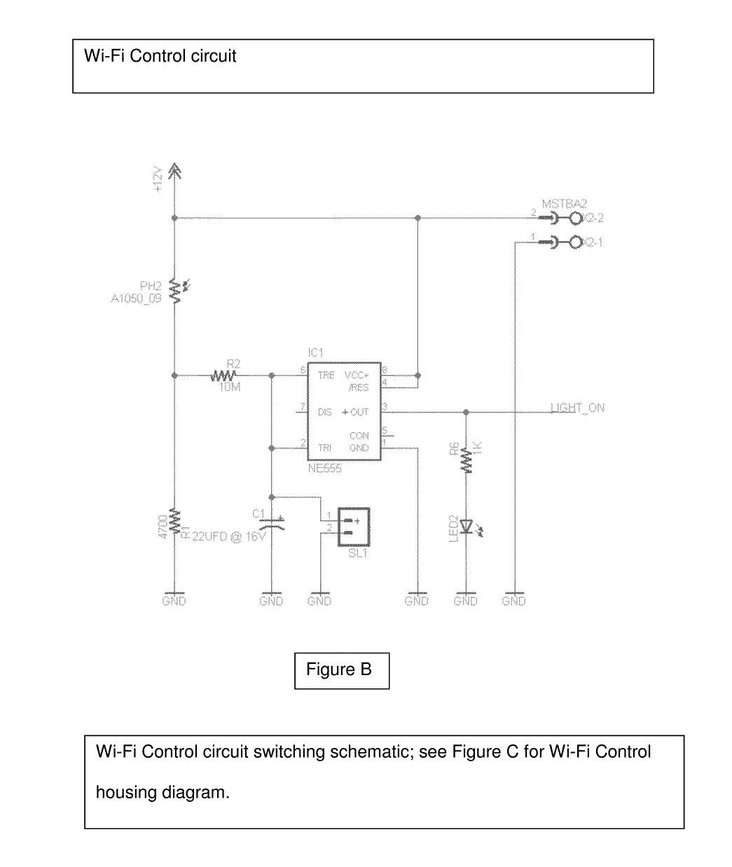

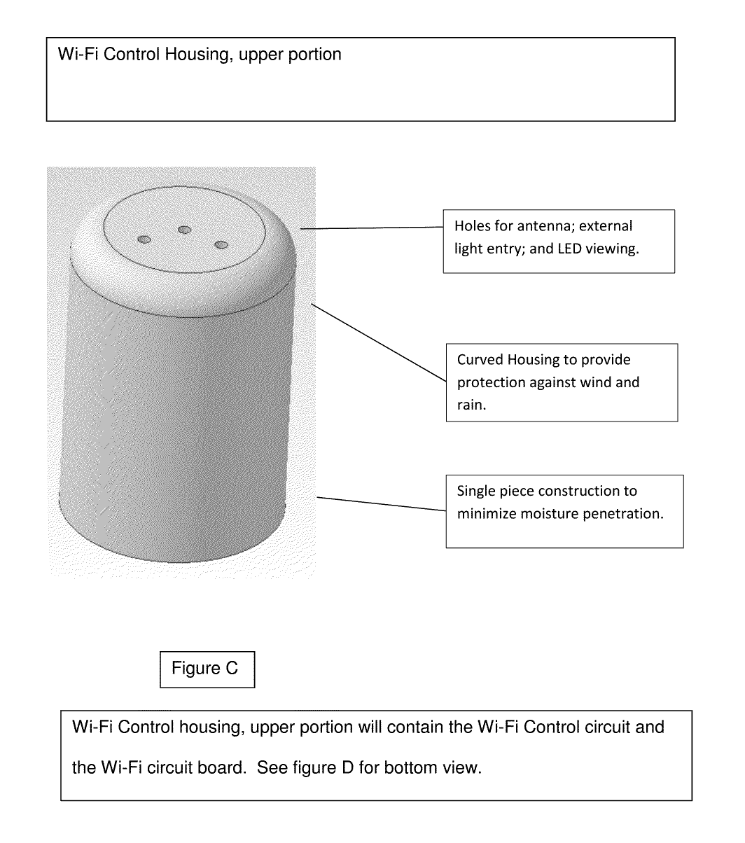

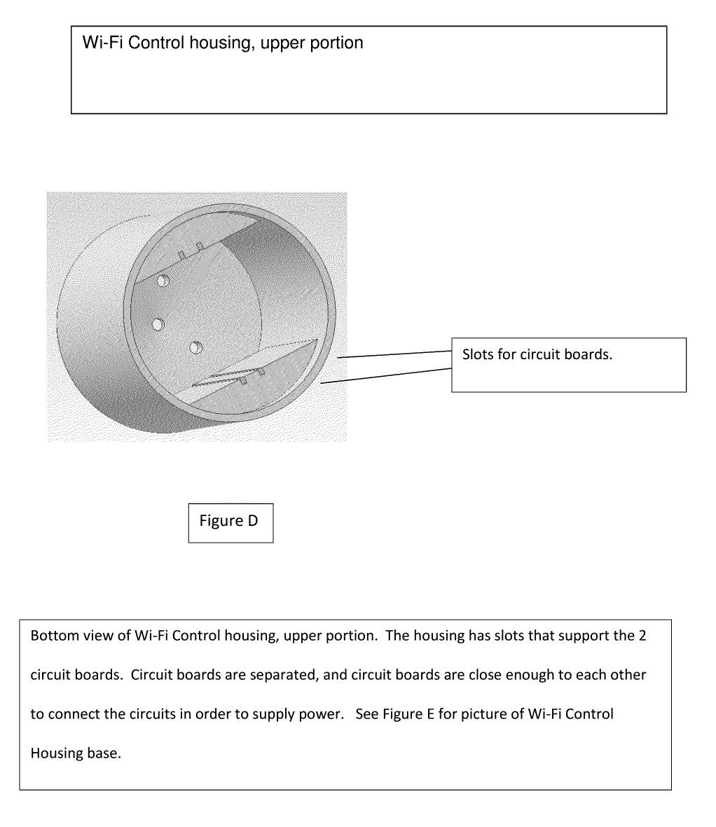

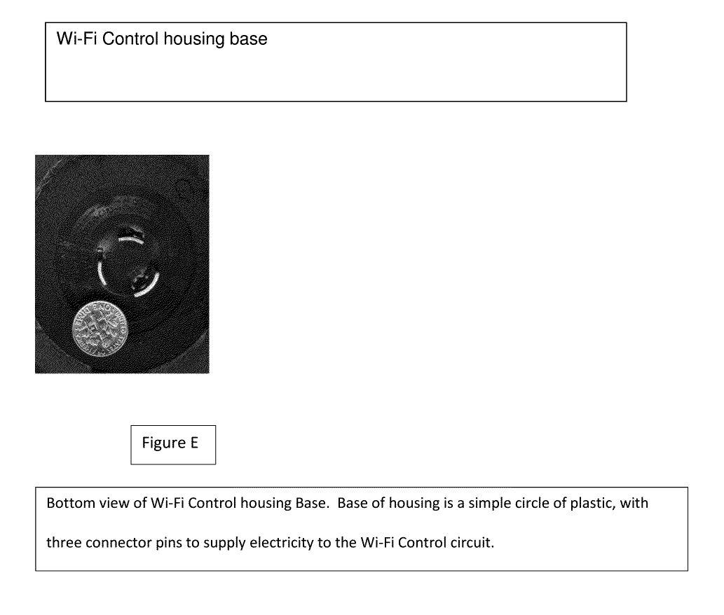

In 1985, the US Federal Communication Commission specified 3 frequencies that could be used to transmit radio waves, without getting a license. In 1997, The Institute of Electrical and Electronics Engineers (IEEE) developed standards for Wi-Fi communication. The IEEE standards are updated every few years to provide faster and better integration between different brands of Wi-Fi devices.

This invention is a control circuit to turn on and off a device (e.g. streetlight) and power a Wi-Fi repeater. One embodiment of the invention is to place the invention atop a streetlight, to allow for additional range of Internet access.

### TECHNICAL FIELD AND INDUSTRIAL APPLICABILITY OF THE INVENTION

This invention relates to creating Internet access on a wide-spread, low-cost basis. The present invention relates particularly to a Wi-Fi Control circuit. A Wi-Fi repeater and a device (e.g. streetlight) are powered and controlled by this invention.

### BACKGROUND OF THE INVENTION

Communication between computers via the Internet Protocol was initiated in 1966. Wires carry the signals between computers or networks of computers. In 1992, wireless Internet communication has come into use.

Streetlights have been in use in the United States since 1792. The height of the streetlight, combined with its electrical power, makes it an ideal location for a Wi-Fi Repeater. The light (e.g. streetlight) and the repeater will be powered and controlled by the Wi-Fi Control circuit.

### SPECIFICATION

### Description

This invention consists of a circuit that performs the functions of controlling a device (for example: a streetlight) and providing electricity to a Wi-Fi repeater.

### Parts and Functionality (See Figure A, B, C, D, E):

a. Housing base has 3 pins, which are connected to 110 v AC power, neutral, and ground. See figure E.
b. Power to the Wi-Fi repeater is supplied by using a “switcher”, which takes some of the AC 110 v and transforms the electricity into 12 v DC. Part is Module 4, in Figure A.
c. Power to the Wi-Fi repeater is provided by 2-wire cable plugs on board with 2-pin header, plugs into repeater with RJ45 connector (locking).
d. The photo-resistor detects light external to the Wi-Fi Control circuit. In the absence of external light (e.g. sunlight), the photo-resistor will allow current to flow. Part is PH2, Figure B.
e. A capacitor is charged, which takes 4 minutes. When capacitor reaches high enough voltage, the microchip will supply 12 v DC to Light_On. See Figure B; Capacitor part is C1; microchip part is IC1.
f. Microchip also turns on an LED, useful for testing.
g. 12 v DC power arrives at the Light_On connection. See Figure B, and then see Figure A.
h. This will trigger the Solid State Relay to connect the device (e.g. streetlight) to 110 v AC. Part is Module 3, in Figure A.
i. Device (e.g. streetlight) will turn on.
j. When external light, such as sunlight, is present, the photo-resistor will go to high resistance. See Figure B, part PH2.
k. A capacitor is dis-charged, which takes 4 minutes. When capacitor reaches low enough voltage, the microchip will switch-off the 12 v DC. See Figure B; Capacitor part is C1; microchip part is IC1.
l. Light_On in Figure B and in Figure A will be 0 v.
m. This will trigger the Solid State Relay to dis-connect the device (e.g. streetlight) from 110 v AC. Part is Module 3, in Figure A.
n. Device (e.g. streetlight) will turn off.
o. Plastic housing and base for Wi-Fi Control circuit and Wi-Fi circuit boards. Housing provides protection from the weather for both circuit boards, holds both circuit boards in a steady position, and contains 3 pins to supply 110 v AC electricity. See Figure C, Figure D, and Figure E.

### Specification (Continued)

### Description (Continued)

### Parts and Functionality (See Figure A, B, C, D, E) (Continued)

Best way to practice the invention: build a circuit as described in figures A and B, AC power supply, standard IEEE Wi-Fi circuit, and the housing as shown in figures C, D, and E.

Although the present invention has been described with reference to preferred embodiments, numerous modifications and variations can be made and still fall within the scope of the invention.

Increasing or decreasing the scale of the preferred embodiment and/or increasing the number of instances of the embodiment will still fall within the scope of the invention.

1. Wi-Fi Control circuit is achieved by constructing an electronic circuit comprising:
a. “Switcher” microchip, AC 110 v and transforms the electricity into 12 v DC,
b. photo-resistor, detects light external,
c. capacitor, which charges and dis-charges,
d. microchip to switch power on and off,
e. solid state relay.

2. Based on the Wi-Fi Control circuit from claim 1, in the absence of external light (e.g. sunlight), the photo-resistor will allow current to flow.

3. Based on the Wi-Fi Control circuit from claim 1, When capacitor reaches high enough voltage, the microchip will supply 12 v DC to Light_On.

4. Based on the Wi-Fi Control circuit from claim 1, Solid State Relay to connect the device (e.g. streetlight) to 110 v AC. Device (e.g. streetlight) will turn on.

5. Based on the Wi-Fi Control circuit from claim 1, when external light, such as sunlight, is present, the photo-resistor will go to high resistance.

6. Based on the Wi-Fi Control circuit from claim 1, when capacitor reaches low enough voltage, the microchip will switch-off the 12 v DC.

7. Based on the Wi-Fi Control circuit from claim 1, the Solid State Relay will dis-connect the device. Device (e.g. streetlight) will turn off.

8. Based on the Wi-Fi Control circuit from claim 1, numerous modifications and variations can be made and still fall within the scope of the invention.

9. Based on the Wi-Fi Control circuit from claim 1, increasing or decreasing the scale of the preferred embodiment and/or increasing the number of instances of the embodiment will still fall within the scope of the invention.

10. Wi-Fi Control circuit housing is achieved by constructing a container comprising:
a. Wi-Fi Control housing, upper portion,
b. Wi-Fi Control housing base with 3 pins.

11. Based on the Wi-Fi Control circuit housing from claim 10, housing provides protection from the weather for both circuit boards.

12. Based on the Wi-Fi Control circuit housing from claim 10, holds both circuit boards in a steady position.

13. Based on the Wi-Fi Control circuit housing from claim 10, 3 pins to supply 110 v AC electricity.

14. Based on the Wi-Fi Control circuit housing from claim 10, numerous modifications and variations can be made and still fall within the scope of the invention.

15. Based on the Wi-Fi Control circuit housing from claim 10, increasing or decreasing the scale of the preferred embodiment and/or increasing the number of instances of the embodiment will still fall within the scope of the invention.
